(19) United States
(12) Patent Application Publication
(10) Pub. No.: US 2010/0322540 A1
(43) Pub. Date: Dec. 23, 2010

(54) AEROSTATIC BEARING

(76) Inventor: Frank Peter Wardle, Swindon (GB)

Correspondence Address: KNOBBE MARTENS OLSON & BEAR LLP, 2040 MAIN STREET, FOURTEENTH FLOOR, IRVINE, CA, 92614, US

(21) Appl. No.: 12/811,352

(22) PCT Filed: Jan. 13, 2009
(86) PCT No.: PCT/GB2009/000086

§ 371 Date: Aug. 17, 2010

(30) Foreign Application Priority Data
Jan. 14, 2008 (GB) 0800557.1

(51) Int. Cl. F16C 32/06

(52) U.S. Cl. 384/100

(57) ABSTRACT

An aerostatic bearing including a first bearing surface (28); a second bearing surface (32) which is juxtaposed to face the first bearing surface (28) and at least one fluid inlet (38) provided in one of the first and second bearing surface (28), (32). An inlet restriction (40) for restricting a flow rate of compressible fluid to and/or from said fluid inlet (38) and at least one recess (34) are provided in one of the first and second bearing surfaces (28, 32); the or each said recess (34) being in fluid communication with the or each said fluid inlet (38). There is also provided at least one outlet restriction (35) which is in fluid communication with the said at least one recess (34) and which restricts a flow rate at which compressible fluid exits the bearing; and at least one protrusion (42) which is provided on a surface defining at least part of the said at least one recess (34). The/each protrusion (42) lies entirely within said at least one recess (34).

This invention relates to an aerostatic bearing.

It is well known within applications such as ultra high precision machine tools and printed circuit board drilling machines to use aerostatic bearings, as such bearings are capable of accurate running at high rotational speeds.

It is common for aerostatic bearings to function by the supply of an externally pressurised fluid, particularly compressed air, wherein the fluid serves to either reduce friction or prevent contact between the bearing surfaces. There are many widespread different geometries of aerostatic bearing, including cylindrical journal, annular thrust, conical, spherical, rectangular and circular pad bearings.

In general, both the load carrying capacity and stiffness of known aerostatic bearings are low when compared to other bearing types and this not only limits the applications that they can be used in, but also compromises their performance.

A known concept used in an attempt to improve the stiffness and load carrying capacity of said bearings is that of modifying the surface geometry of the bearing surfaces so as to enhance the airflow and pressure distribution within the bearing. However, such modifications may result in a reduction in overall bearing performance as removing parts of a bearing surface leads to an increase in the volume of fluid between the bearing surfaces, hence reducing the damping capacity of the bearing and giving it a poor dynamic response. In the extreme, such modifications may even lead to self-excited pneumatic instability.

The present invention seeks to ameliorate the hereinbefore described disadvantages.

According to the present invention there is provided an aerostatic bearing comprising a first bearing surface; a second bearing surface which is juxtaposed to face the first bearing surface; at least one fluid inlet provided in one of the first and second bearing surface; an inlet restriction for restricting a flow rate of compressible fluid to and/or from said fluid inlet; at least one recess provided in one of the first and second bearing surfaces, the or each said recess being in fluid communication with the or each said fluid inlet; at least one outlet restriction which is in fluid communication with the said at least one recess and which restricts a flow rate at which compressible fluid exits the bearing; and at least one protrusion which is provided on a surface defining at least part of the said at least one recess, the or each protrusion lying entirely within said at least one recess.

Preferably, the said at least one protrusion extends between two different surfaces defining at least part of the said at least one recess.

Advantageously, a plurality of said protrusions are provided.

Desirably, the said at least one protrusion has a height which is less than a depth of the said at least one recess. This is so as to ensure that the protrusion does not in use engage the opposing bearing surface.

Preferably, said surface defining at least part of the said at least one recess is a non-planar textured surface, the said at least one protrusion forming a part of the texturing.

Advantageously, the total surface area provided by the or each said recess is at least ten percent inclusive of the total surface area of the first or second bearing surface in which the recess is provided, preferably at least 50%, especially at least 75%.

Preferably, a plurality of spaced-apart said fluid inlets are provided. This ensures that should one inlet be obstructed, fluid can still be supplied to the bearing.

Advantageously, a said fluid inlet is provided in the or each said recess.

Desirably, the said fluid inlet is provided in or on the said surface which defines at least part of the said at least one recess and on which the said protrusion is provided.

Advantageously, the inlet restriction includes a part which is provided in or on the said surface on which the said protrusion is provided.

Desirably, the said part of the inlet restriction is a raised land which surrounds the fluid inlet.

Preferably, the aerostatic bearing further comprises a continuous fluid channel which connects the or each fluid inlet with the or each recess, thus allowing fluid communication therebetween.

Desirably, a said outlet restriction is at or adjacent to the said recess.

Advantageously, the or each said outlet restriction includes a wall which defines at least part of the said recess and a land adjacent to the said recess, the said wall and land forming a step.

Preferably, the aerostatic bearing further comprises a fluid flow path for compressible fluid, the fluid flow path extending from the said at least one fluid inlet, through the inlet restriction, into the said at least one recess, through the said at least one outlet restriction, before exiting the bearing.

Desirably, the first bearing surface forms part of a rotor which is connected or connectable to a load, and the second bearing surface forms part of a bearing housing in which the rotor is provided.

The invention will further be described, by way of example, with reference to the accompanying drawings, in which:

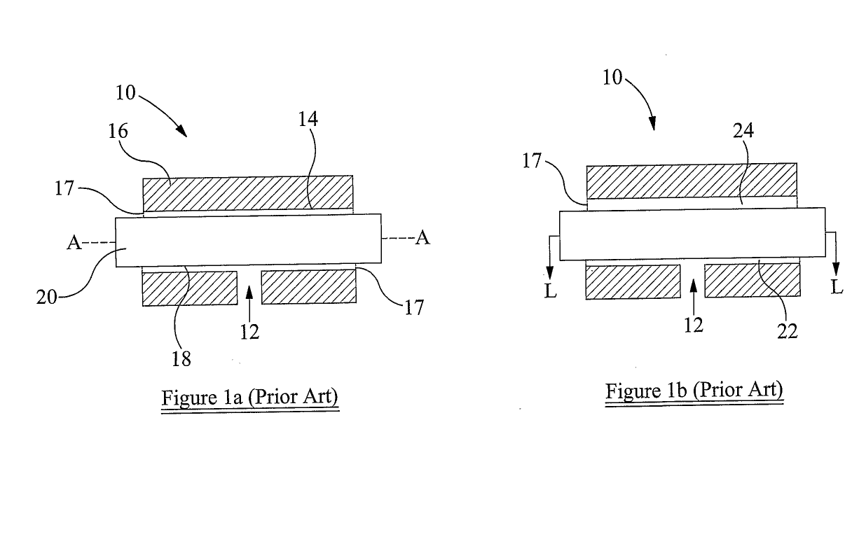

FIG. 1a shows a diagrammatic cross-sectional view of a prior art cylindrical aerostatic bearing, parallel to its axis of rotation;

FIG. 1b shows the same view of the same bearing as shown in FIG. 1a, with a load applied to a component of said bearing;

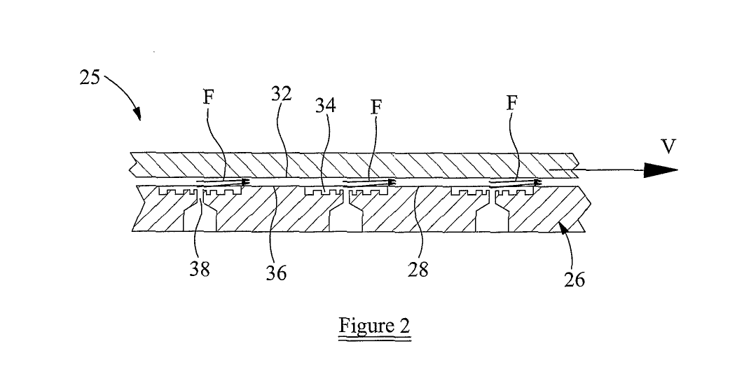

FIG. 2 shows a schematic cross sectional view of a portion of an aerostatic bearing in accordance with the current invention, said cross section being taken parallel to an axis of rotation of the bearing in use;

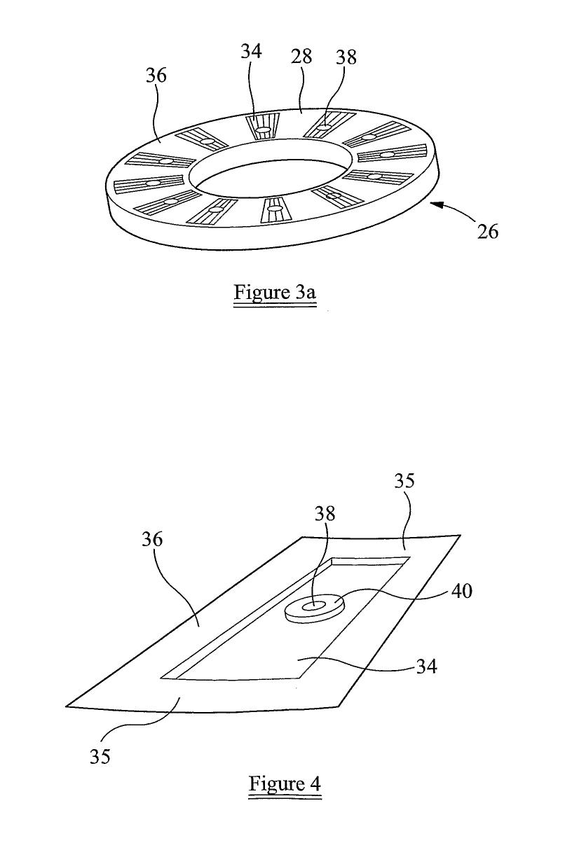

FIG. 3a shows a schematic perspective view of a first bearing component, which forms part of the embodiment of the invention shown in FIG. 2;

FIG. 3b shows an expanded view of a recess portion of the bearing as shown in FIG. 3a;

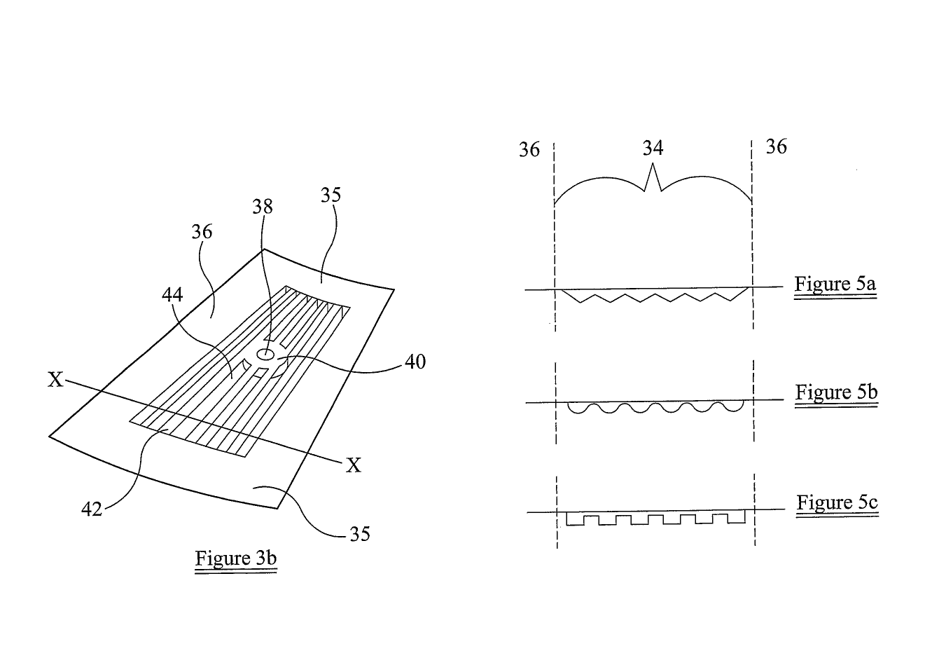

FIG. 4 shows the same view of the same recess portion as seen in FIG. 3b, with protrusion and groove portions omitted for the sake of clarity;

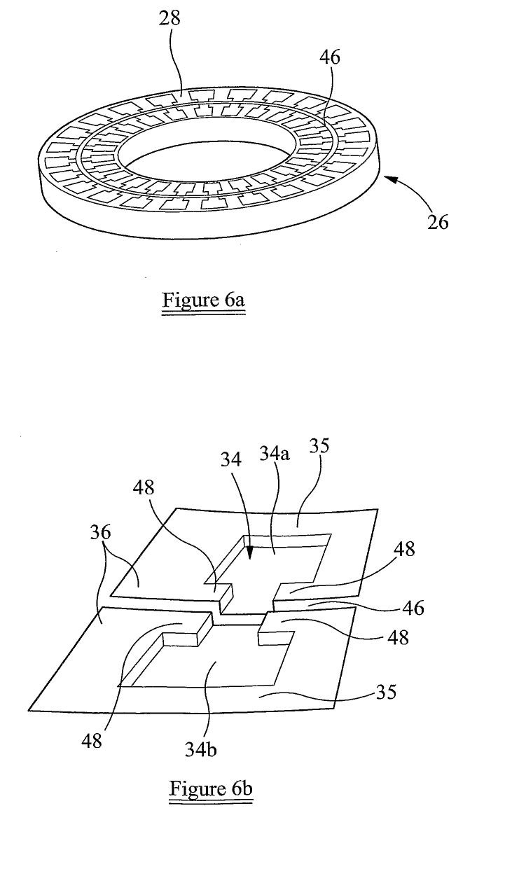

FIG. 5a shows a profile of the recess portion shown in FIG. 3b along the line X-X;

FIG. 5b shows an alternative profile of the recess portion shown in FIG. 3b along the line X-X;

FIG. 5c shows a further alternative profile of the recess portion shown in FIG. 3b along the line X-X;

FIG. 6a shows a schematic perspective view of a first bearing component of an alternative embodiment of the present invention; and

FIG. 6b shows an expanded view of a recess portion of the bearing as shown in FIG. 6a.

As can be seen most clearly in FIG. 1a, the general principle behind the operation of a cylindrical aerostatic bearing 10 is that a compressed fluid at high pressure is provided through an inlet 12. The fluid flows between an outer bearing surface 14, which is part of the bearing housing 16 and an inner bearing surface 18 which is part of the bearing rotor 20. In use, the rotor 20 has an axis of rotation marked by line A-A. The fluid then exits the bearing though an outlet 17 formed between the housing 16 and rotor 20 at either end of the bearing 10. The fluid is most commonly compressed air, but may be any other compressible fluid. The fluid serves to reduce friction and/or prevent contact between the bearing surfaces 14, 18.

As shown in FIG. 1a, in the absence of any load applied to the rotor 20, the separation between the bearing surfaces 14, 18 is approximately uniform. FIG. 1b shows that a radial load L applied to the rotor 20 results in the separation between the bearing surfaces 14, 18 being less on the side 22 of the bearing 10 towards which the load L is urging the rotor 20 compared to the side 24 away from which the load L is urging the rotor 20. Where the relative separation between the surfaces 14, 18 is greater, the relative volume of fluid between the surfaces 14, 18 is greater and as such the relative pressure of the fluid between the rotor 20 and housing 16 is less. In this way there is a pressure difference between fluid at side 22 of the bearing, towards which the load L is urging the rotor 20, and the fluid at side 24 of the bearing, away from which the load L is urging the rotor 20. This pressure difference results in a force on the rotor 20 which opposes the load L. As such the pressure difference supports the load L.

Due to the fact that the inlet 12 is relatively central along the length of the rotor 20 compared to the positions of the outlets 17 at either end of said rotor 20, there is a pressure gradient along the length of the rotor 20 between the inlet 12 and each outlet 17: the pressure being a maximum adjacent the inlet 12 and a minimum adjacent an outlet 17. The net effect is that under load L, the bearing 10 only develops a substantial pressure difference over a fraction of its total area: that which is adjacent the inlet 12.

The theoretical maximum load such a bearing can support is given by the product of the pressure of the fluid at the inlet 12 and the area of the bearing surfaces 14, 18. However, the load carrying capacities of practical air bearing designs are normally only 30-40% of this.

Known aerostatic bearings, such as that shown in FIG. 1a, may also comprise a restrictor (not shown) placed upstream from the inlet 12 to regulate the fluid pressure at the inlet. The restrictor generally comprises an orifice through which the fluid passes before passing through the inlet 12. This type of bearing configuration is known as an inlet restrictor bearing.

FIG. 2 shows part of an embodiment of an annular thrust bearing 25 in accordance with the present invention. The bearing 25 comprises a first annular component 26, in the form of a bed having a first bearing surface 28, and a second annular component 30, shown in FIG. 2, having a second bearing surface 32 which is juxtaposed to face the first bearing surface 28. In use, there is a relative angular motion between the first component 26 and the second component 30 as indicated by arrow V in FIG. 2.

In use, either of the first and second components 26, 30 may be mechanically linked to a load. Typically it is the second component 30 which is mechanically linked to a load and rotates, whilst the first component 26 remains stationary. The stationary component may form part of a bearing housing, whist the rotating component may form part of a rotor.

The first bearing surface 28 comprises a plurality of similar recesses 34 angularly spaced around the component 26. The recesses 34 are of constant arc width, are equi-angularly spaced around the component 26 and extend close to but do not intersect the outside diameter and bore of the first annular component 26. Thus, the recesses 34 are surrounded by a plurality of similar plateau-like lands: those at the outside diameter and at the bore of the first annular component 26 are known as outlet restriction lands 35 and those lands intermediate adjacent recesses are known as side lands 36.

In an optimised bearing, the recess depth may be between 0.5 and 5 times the separation between the second bearing surface 32 and the outlet restriction lands 35 and side lands 36. Also, the area of each recess 34 times the number of recesses of the first bearing surface 28 is at least 10% of the first bearing surface area. The total area occupied by the recesses 34 is preferably in excess of 50% of the first bearing surface 28 area depending on the bearing application, especially being at least 75%. The optimum number of recesses 34 will be typically between 8 and 24 depending on bearing size.

Compressed fluid, for example a gas, a gas mixture or air at high pressure, is supplied to each recess 34 through an inlet 38 preferably situated near the centre of each recess 34. Each inlet 38 may be surrounded by a raised plateau-like inlet restriction land 40 which does not extend out of the recess 34, i.e. beyond the height of the outlet restriction lands 35 and side lands 36.

The inlets 38 are in one embodiment of the invention between 0.05 mm and 1.0 mm in diameter. Together with the surrounding land 40 they provide a restriction to the rate of inlet of fluid. Smaller inlet diameters of between 0.05 mm and 0.3 mm may be used in the absence of inlet restriction lands as the smaller diameter provides for a great enough inlet restriction on its own. Conversely, with larger diameter feed holes, the lands 40 provide the majority of the inlet restriction. The lands may be of any shape, for example non-circular, such as rectangular, or circular.

The width of each recess 34 is optimised by numerical analysis of pressure distribution of the fluid intermediate the bearing surfaces 28, 32 so as to achieve maximum bearing stiffness. The bearing stiffness is calculated by dividing the load L applied to the bearing by the change in separation between the bearing surfaces 28, 32.

During the operation of the bearing 25, the function of the side lands 36 is predominantly to bear any load applied to the bearing. This is done by the fluid exerting a force on the side lands 36. The function of the outlet restriction lands 35 is predominantly to control fluid flow out of the recesses 34. The main function of the recesses 34 is therefore to control pressure distribution on the side lands 35.

The use of recesses 34 results in a much more constant pressure profile of the fluid radially across the bearing compared to a similar bearing without recesses 34. As such, there is less decay of fluid pressure from the inlets 28 to the outlet lands 35 compared to that of a similar bearing without recesses 34. The greater total pressure across a bearing with recesses 34 therefore results in an increase in stiffness and load capacity.

As shown in FIGS. 2, 3a and 3b, but not in FIG. 4, the surface defining each recess 34 may comprise texturing, i.e. be non-flat or non-planar. FIG. 3b shows a preferred type of texturing consisting of a plurality of fine alternating radial projections or protrusions 42 and grooves 44. The grooves 44 may be of different depths, but in this embodiment are all of the same depth, their depth defining the depth of the recess 34. The protrusions 42 may also be of different heights, their height always being below that of the side lands 36 and outlet restriction lands 35, but in this embodiment they are all of equal height.

The profile of the protrusions 42 and grooves 44 across the recess 34 (as indicated by the line X-X in FIG. 3b) may vary depending on the method of manufacture. FIGS. 5a, 5b & 5c show that possible profiles include a) saw wave, b) sinusoidal or continuously curving, and c) square wave. The profile may in fact be any pattern, whether repeating or not.

Alternatives to radial protrusions 42 and grooves 44 may also be used. For example, annular projections and grooves or isotropic surface textures consisting of a combination of radial and annular grooves. However, radial protrusions 42 and grooves 44 are preferred as it has been found through research that they generate more aerodynamic lift on high-speed bearings.

The process of aerodynamic lift is best seen and understood in FIG. 2. The effect of relative motion in direction V between the two bearing surfaces 28, 32 is to drag fluid out of the recesses into the side lands 36 as shown by the arrows F. Due to the fact that the separation between the side lands 36 and the second bearing surface 32 is less than the separation between a surface defining the recesses 34 and the second bearing surface 32, as the fluid is dragged up the ‘step’ between the recess 34 and side lands 36, the fluid is compressed, resulting in an increase in its pressure. The increase in fluid pressure results in a force, the action of which seeks to increase the separation between the two bearing surfaces 28 and 32, also known as the generation of aerodynamic lift. Maximum lift occurs when the recess width is similar to the side land width.

During the operation of the bearing 25, high-pressure fluid flows into the recesses 34 via the inlets 38 and respective inlet restriction lands 40. The fluid fills the recesses 34 and then flows predominantly in a radial direction towards the inner and outer edges of the bearing components 26, 30, which are at atmospheric pressure. The resistance to fluid flow at the bearing edges, and hence out of the bearing, is made relatively high by controlling the widths of the outlet restriction lands 35 between the recess 34 ends and the bearing edges. The greater the width of the land 35, the greater the restriction and hence the greater the resistance to fluid flow out of the bearing.

The resistance to fluid flow within each recess 34 is controlled by its depth: the greater the depth the less the fluid flow resistance. The fluid flow resistance within each recess 34 is low relative to that from the inlets 38 and inlet restriction lands 40; and also low relative to that from the outlet restriction lands 35.

The resistance to fluid flow from the inlets 38 and inlet restriction lands 40 is such that it is lower than that of the outlet restriction lands 35. This ensures that each recess 34 fully fills with fluid during operation of the bearing 25.

Critical to the response time of the bearing to the application of a load, a component of which is parallel to the separation between the bearing surfaces 28, 32, is the rate at which the recesses 34 can be filled with fluid. The response time is deemed to be the time taken for the pressure in the bearing to reach an equilibrium value after an instantaneous step change in load L applied to the bearing. Two main factors influencing the rate at which the recesses 34 can be filled are the volume of the recesses 34 and the rate at which fluid flows both into and out of each recess 34. The smaller the volume of each recess 34, the less fluid, and hence the less time, is required to fill it and as such the response time of the bearing is generally faster. The textured surfaces of the recesses 34 serve to decrease the volume of the recess for a given recess depth and bearing surface 28, 32 area and as such generally results in a decrease in response time, and is as such beneficial.

In an optimised bearing the response time is chosen to be low enough so as to avoid interactions with rigid body modes of vibration of the system of which the bearing is a part.

A further embodiment of an aerostatic bearing in accordance with the present invention is shown in FIGS. 6a and 6b. For the avoidance of doubt, similar references refer to similar parts and therefore further detail description is omitted. In this case, the surface 28 of the first bearing component 26 comprises a continuous annular inlet channel 46. The annular inlet channel 46 is preferably centrally located on the annular surface 28 intermediate the inner and outer edges, however this need not be so. At the base of the inlet channel 46 are a plurality of equi-distantly spaced feed holes (not shown) through which the compressed fluid is supplied to the bearing through low resistance delivery lines.

It is envisaged that, in an alternative embodiment of the invention, the base of the channel 46 may only have one feed hole supplying the compressed fluid to the bearing.

The first bearing surface 28 also comprises a plurality of similar recesses 34 equi-angularly spaced around the component 26. The recesses 34 are bisected by the inlet channel 46 to form a recess part 34a adjacent the bearing bore and a recess part 34b adjacent the outside edge of the bearing. The recesses 34 are of generally constant arc width and extend close to, but do not intersect, the outside diameter and bore of the first annular component 26. Thus, the recesses 34 are surrounded by a plurality of similar plateau-like outlet restriction lands 35 and side lands 36. In addition, at or adjacent to the inlet channel 46, the arc width of the recess parts 34a, 34b is reduced compared to that of the remainder of the recess parts 34a, 34b. This reduction in arc width is as a result of the incorporation of inlet restriction portions 48 into the side lands 36. The inlet restriction portions 48 and hence the reduction in arc width of the recess parts 34a, 34b act so as to restrict the rate of flow of fluid into each recess 34 from the inlet channel 46. In every other respect this embodiment functions in a similar manner to the embodiment hereinbefore described.

FIGS. 6a and 6b show the current embodiment with the recess 34 being free of texture. However, it is envisaged that this embodiment may also comprise a surface defining each recess 34 with protrusions akin to those in the hereinbefore described first embodiment.

In both the hereinbefore described embodiments, the second bearing surface 32 is generally planar. However this need not be so: It too may comprise inlets and/or recesses.

Although the optional raised plateau-like inlet restriction land mentioned above is the same height as the or each projection or protrusion, the inlet restriction land, if utilised, may be above or below the upper edge or surface of the or each protrusion. The inlet restriction land, however, is always above the lowermost or bottom surface of the recess.

The protrusions themselves may have the same or different heights. Equally, the grooves may have the same or different depths.

Although a plurality of protrusions are suggested, benefits have been seen from the use of only one protrusion.

Furthermore, and in particular for a thrust bearing, it is feasible that the arc width of a single one of the recesses can extend around all or a majority of the first bearing surface. In this case, the recess may have a continuous or endless arcuate extent. As such, although not limited to such, only a single recess may optionally be provided. This arrangement offers enhancement in performance over and above a known thrust bearing. Although no aerodynamic lift would be generated by a continuous recess, it has been determined that a useful improvement in aerostatic lift can be obtained.

The protrusion provided in the recess can extend radially, arcuately, transversely, or longitudinally, depending on the type of aerostatic bearing that the recess and protrusion are being applied to.

One or more of the protrusions or projections may also extend from and between sides of the recess, or may not meet a side or sides of the recess.

It will be appreciated that a wide range of modifications and alterations may be made to the embodiments of the invention described hereinbefore without departing from the scope of the invention as defined by the appended claims. Such examples include, the application of recesses designed according to the above principles to different bearing geometries including cylindrical journal, conical, spherical, circular and rectangular pad aerostatic bearings.

1. An aerostatic bearing comprising:
a first bearing surface;
a second bearing surface which is juxtaposed to face the first bearing surface;
at least one fluid inlet provided in one of the first and second bearing surface;
an inlet restriction for restricting a flow rate of compressible fluid to, and/or from said fluid inlet;
at least one recess provided in one of the first and second bearing surfaces, the or each said recess being in fluid communication with the or each said fluid inlet;
at least one outlet restriction which is in fluid communication with the said at least one recess and which restricts a flow rate at which compressible fluid exits the bearing; and
at least one protrusion which is provided on a surface defining at least part of the said at least one recess, the or each protrusion lying entirely within said at least one recess.

2. An aerostatic bearing as claimed in claim 1, wherein the said at least one protrusion extends between two different surfaces defining at least part of the said at least one recess.

3. An aerostatic bearing as claimed in claim 1, wherein the said at least one protrusion has a height which is less than a depth of the said at least one recess.

4. An aerostatic bearing as claimed in claim 1, wherein the said surface defining at least part of the said at least one recess is a non-planar textured surface, the said at least one protrusion forming a part of the texturing.

5. An aerostatic bearing as claimed in claim 1, wherein a longitudinal extent of the said at least one protrusion is parallel to a rotational axis of the first or second bearing surface.

6. An aerostatic bearing as claimed in claim 1, wherein a longitudinal extent of the said at least one protrusion is transverse to a rotational axis of the first or second bearing surface.

7. An aerostatic bearing as claimed in claim 1, wherein a total surface area provided by the or each said recess is at least ten percent of the total surface area of the first or second bearing surface in which the recess is provided.

8. An aerostatic bearing as claimed in claim 7, wherein the total surface area provided by the or each said recess is at least fifty percent inclusive of the total surface area of the first or second bearing surface in which the recess is provided.

9. An aerostatic bearing as claimed in claim 8, wherein the total surface area provided by the or each said recess is at least seventy five percent inclusive of the total surface area of the first or second bearing surface in which the recess is provided.

10. An aerostatic bearing as claimed in claim 1, wherein said at least one fluid inlet is provided in the or each said recess.

11. An aerostatic bearing as claimed in claim 10, wherein the said fluid inlet is provided in or on the said surface which defines at least part of the said at least one recess and on which the said protrusion is provided.

12. An aerostatic bearing as claimed in claim 1, wherein the inlet restriction includes a part which is provided in or on the said surface on which the said protrusion is provided.

13. An aerostatic bearing as claimed in claim 12, wherein the said part of the inlet restriction is a raised land which surrounds the fluid inlet.

14. An aerostatic bearing as claimed in claim 1, further comprising a continuous fluid channel which connects the or each fluid inlet with the or each recess, thus allowing fluid communication therebetween.

15. An aerostatic bearing as claimed in claim 14, wherein the continuous fluid channel bisects the or each said recess.

16. An aerostatic bearing as claimed in claim 14, wherein the inlet restriction includes a narrow portion of the or each said recess at or adjacent to the fluid channel.

17. An aerostatic bearing as claimed in claim 14, wherein a said inlet restriction is provided each side of the continuous fluid channel.

18. An aerostatic bearing as claimed in claim 1, wherein a said outlet restriction is at or adjacent to the said recess.

19. An aerostatic bearing as claimed in claim 1, wherein the or each said outlet restriction includes a wall which defines at least part of the said recess and a land adjacent to the said recess, the said wall and land forming a step.

20. An aerostatic bearing as claimed in claim 1, further comprising a fluid flow path for compressible fluid, the fluid flow path extending from the said at least one fluid inlet, through the inlet restriction, into the said at least one recess, through the said at least one outlet restriction, before exiting the bearing.

21. An aerostatic bearing as claimed in claim 1, wherein the first bearing surface forms part of a rotor which is connected or connectable to a load, and the second bearing surface forms part of a bearing housing in which the rotor is provided.

22. An aerostatic bearing as claimed in claim 21, wherein the said at least one recess is provided on the second bearing surface.
